(19) United States
(12) Patent Application Publication
(10) Pub. No.: US 2024/0311092 A1
(43) Pub. Date: Sep. 19, 2024

(54) DATA PROCESSING METHOD AND RELATED APPARATUS

(71) Applicant: Huawei Cloud Computing Technologies Co., Ltd., Gui'an (CN)

(72) Inventors: Yawei Wang, Shanghai (CN); Ilya Seleznev, Novosibirsk (RU); Pavel Petrochenko, Novosibirsk (RU); Denis Denisenko, Novosibirsk (RU)

(73) Assignee: Huawei Cloud Computing Technologies Co., Ltd., Gui'an (CN)

(21) Appl. No.: 18/673,285

(22) Filed: May 23, 2024

Related U.S. Application Data
(63) Continuation of application No. PCT/CN2022/133729, filed on Nov. 23, 2022.

(30) Foreign Application Priority Data
Nov. 29, 2021 (RU) RU2021134789

(51) Int. Cl. G06F 8/30

(52) U.S. Cl. CPC G06F 8/315

(57) ABSTRACT

In a data processing method, a processor obtains N objects that belong to a same class of object-oriented programming (OOP). The processor determines M groups of data based on attribute values of M attributes included in each of the N objects. The M groups of data are in a one-to-one correspondence with the M attributes, and each of the M groups of data indicates attribute values of a corresponding attribute of the N objects. The processor then stores the M groups of data by using M storage space sets respectively.

### CROSS-REFERENCE TO RELATED APPLICATIONS

This application is a continuation of International Application PCT/CN2022/133729, filed on Nov. 23, 2022, which claims priority to Russian Patent Application RU2021134789, filed on Nov. 29, 2021. The disclosure of the aforementioned application is hereby incorporated by reference in its entirety.

### TECHNICAL FIELD

Embodiments of this application relate to the field of information technologies, and more specifically, to a data processing method and a related apparatus.

### BACKGROUND

Object-oriented programming (OOP) is a programming paradigm based on the concept of objects, and is also an abstract policy for program development. OOP may contain data, characteristics, code, and methods. An object refers to an instance of a class. In OOP, the object is used as a basic unit of a program, and the program and data are encapsulated in the object, to improve reusability, flexibility, and scalability of software.

A system does not allocate storage space to a class. After the class is instantiated, the system allocates storage space to an object. In other words, when storing an object, the system allocates corresponding storage space to each object. When the system needs to read a plurality of objects of a same class, the system needs to find the plurality of objects of the same class from different storage space. Consequently, allocating the storage space based on the object may cause low reading efficiency.

### SUMMARY

Embodiments of this application provide a data processing method and a related device, to provide good data consistency.

According to a first aspect, embodiments of this application provide a data processing method, including: obtaining N objects, where the N objects belong to a same class, each of the N objects includes M attributes, N is a positive integer greater than or equal to 2, and M is a positive integer greater than or equal to 1; determining M groups of data based on attribute values of the M attributes included in the N objects, where the M groups of data are in a one-to-one correspondence with the M attributes, and each of the M groups of data indicates attribute values of a corresponding attribute of the N objects; and storing the M groups of data by using M storage space sets respectively.

In the foregoing technical solution, attribute values of a same attribute of the N objects that belong to the same class are stored by using a same storage space set. Therefore, the foregoing technical solution provides good data locality. In addition, in the foregoing technical solution, only an attribute value of an object or data indicating an attribute value may be stored without storing some redundant information (for example, an object header and alignment padding). Therefore, the foregoing technical solution saves storage space. Further, only one file may be used to record the M groups of data. This can reduce a quantity of files that need to be stored, and reduce fragmentation in object storage.

With reference to the first aspect, in a possible implementation of the first aspect, the determining M groups of data based on attribute values of the M attributes included in the N objects includes: determining, based on the attribute values of the M attributes included in the N objects, that the M attributes include M₁ first-type attributes, where attribute values of first attributes of any two of the N objects are different, the first attribute is any one of the M₁ first-type attributes, and M₁ is a positive integer greater than or equal to 1 and less than or equal to M; and determining M₁ groups of data, where the M₁ groups of data are in a one-to-one correspondence with the M₁ first-type attributes, N pieces of data included in an i^{th} group of data in the M₁ groups of data respectively indicate attribute values of an i^{th} first-type attribute in the M₁ first-type attributes of the N objects, and i=1, . . . , or M₁; and the storing the M groups of data by using M storage space sets respectively includes: storing the M₁ groups of data by using M₁ first storage space sets, where an i^{th} first storage space set in the M₁ first storage space sets includes N pieces of consecutive storage space, and the N pieces of consecutive storage space in the i^{th} first storage space set are respectively used to store the N pieces of data included in the i^{th} group of data.

In the foregoing technical solution, a plurality of pieces of data of a same attribute are stored in consecutive storage space. The consecutive storage space is usually read together according to a cache read rule. Therefore, in the foregoing technical solution, the stored attribute value of the object has good data locality.

With reference to the first aspect, in a possible implementation of the first aspect, the determining M groups of data based on attribute values of the M attributes included in the N objects includes: determining, based on the attribute values of the M attributes included in the N objects, that the M attributes include M₂ second-type attributes, where attribute values of second attributes of any two of the N objects are the same, the second attribute is any one of the M₂ second-type attributes, and M₂ is a positive integer greater than or equal to 1 and less than or equal to M; and determining M₂ groups of data, where data included in a j^{th} group of data in the M₂ groups of data indicates attribute values of a j^{th} second-type attribute in the M₂ second-type attributes of the N objects, and j=1, . . . , or M₂; and the storing the M groups of data by using M storage space sets respectively includes: storing the M₂ groups of data by using M₂ second storage space sets, where storage space included in a j^{th} second storage space set in the M₂ second storage space sets is used to store the data included in the j^{th} group of data.

In the foregoing technical solution, when a stored value of an attribute of an object is a constant, only one value may be stored. In this case, storage space for the object can be further compressed.

With reference to the first aspect, in a possible implementation of the first aspect, the determining M groups of data based on attribute values of the M attributes included in the N objects includes: determining, based on the attribute values of the M attributes included in the N objects, that the M attributes include M₃ third-type attributes, where a third attribute of each of the N objects can be determined based on a function, the third attribute is any one of the M₃ third-type attributes, and M₃ is a positive integer greater than or equal to 1 and less than or equal to M; and determining M₃ groups of data, where a function included in a k^{th} group of data in the M₃ groups of data can determine attribute values of a k^{th} third-type attribute in the M₃ third-type attributes of the N objects, and k=1, . . . , or M₃; and the storing the M groups of data by using M storage space sets respectively includes: storing the M₃ groups of data by using M₃ third storage space sets, where storage space included in a k^{th} third storage space set in the M₃ third storage space sets is used to store the function included in the k^{th} group of data.

In the foregoing technical solution, when an attribute value that can be calculated based on a function is stored, only the corresponding function may be stored instead of storing the specific attribute value. In this case, storage space for the object can be further compressed.

With reference to the first aspect, in a possible implementation of the first aspect, a size of each piece of storage space in each of the M storage space sets is equal to a size of maximum storage space occupied by data indicating an attribute value.

The size of the maximum storage space occupied by the data indicating the attribute value is a size of storage space occupied by a possible maximum value of the attribute value. For example, a maximum value of an attribute value corresponding to data of an int type is 255. In this case, storage space for storing the attribute value may be only 8 bits, instead of 32 bits. In this case, storage space in object storage can be further saved.

With reference to the first aspect, in a possible implementation of the first aspect, the method further includes: obtaining a read instruction, where the read instruction is used to read attribute values of P attributes of one or more of the N objects, and P is a positive integer greater than or equal to 1 and less than or equal to M; determining P storage space sets from the M storage space sets, where the P storage space sets are in a one-to-one correspondence with the P attributes; and respectively determining the attribute values of the P attributes of the one or more objects based on data included in the P storage space sets.

In the foregoing technical solution, when an attribute value of an attribute of an object is read, the attribute value of the attribute may be directly read from a storage space set corresponding to the attribute, instead of reading all attribute values of the object. This can increase a speed of reading the attribute value.

According to a second aspect, embodiments of this application provide a computer device. The computer device includes units configured to implement any one of the first aspect or the possible implementations of the first aspect.

According to a third aspect, embodiments of this application provide a computer device. The computer device includes a processor. The processor is coupled to a memory, and configured to read and execute instructions and/or program code in the memory, to perform any one of the first aspect or the possible implementations of the first aspect.

According to a fourth aspect, embodiments of this application provide a chip system. The chip system includes a logic circuit. The logic circuit is configured to be coupled to an input/output interface, and transmit data through the input/output interface, to perform any one of the first aspect or the possible implementations of the first aspect.

According to a fifth aspect, embodiments of this application provide a computer-readable storage medium. The computer-readable storage medium stores program code. When the computer storage medium is run on a computer, the computer is enabled to perform any one of the first aspect or the possible implementations of the first aspect.

According to a sixth aspect, embodiments of this application provide a computer program product. The computer program product includes computer program code, and when the computer program code is run on a computer, the computer is enabled to perform any one of the first aspect or the possible implementations of the first aspect.

### BRIEF DESCRIPTION OF DRAWINGS

FIG. 1 is a schematic diagram of a data storage manner;

FIG. 2 is a schematic flowchart of a data processing method according to an embodiment of this application;

FIG. 3 is a schematic diagram of a manner of storing a data column 1 to a data column 5;

FIG. 4 is a schematic diagram of a manner of storing a compressed data column 1 to a compressed data column 5;

FIG. 5 is a schematic diagram of a character string pool;

FIG. 6 is a schematic diagram of a manner of storing a compressed data column 1 to a compressed data column 5;

FIG. 7 is a schematic flowchart of a data processing method according to an embodiment of this application; and

FIG. 8 is a schematic block diagram of a structure of a computer device according to an embodiment of this application.

### DESCRIPTION OF EMBODIMENTS

The following describes the technical solutions in embodiments of this application with reference to the accompanying drawings.

To help a person skilled in the art better understand the technical solutions of this application, some terms and technologies related to this application are first described.

### 1. Data Locality

The data locality may also be referred to as locality. There are two different forms of locality: temporal locality and spatial locality. In a program with good temporal locality, a location in a memory that has been referenced once is likely to be referenced a plurality of times in near future. In a program with good spatial locality, if a location in a memory has been referenced once, the program is likely to reference a nearby location in the memory in near future. Generally, a program with good data locality is run faster than a program with poor locality. All layers of a modern computer system, from hardware to an operating system and then to an application, are designed using locality. At the hardware layer, a locality principle allows a computer designer to introduce a small and quick memory of a cache to store instructions and a data item that are recently used, to increase a speed of accessing a main memory. At the operating system layer, a locality principle allows the system to use the main memory as a cache for a recently referenced block in virtual address space.

### 2. Object

A hotspot virtual machine is used as an example. In the hotspot virtual machine, a storage layout of the object in memory may be divided into three areas: an object header, instance data, and alignment padding.

The object header includes a mark field and a class pointer. The mark field (markword) is used to store runtime data of the object, for example, a hash code, a lock status flag, and a lock held by a thread. Lengths of this part of data are respectively 4 bytes and 8 bytes on a 32-bit virtual machine and a 64-bit virtual machine. The class pointer is a pointer that points to class metadata (which is stored in a method area) of the object. The virtual machine uses this pointer to determine a specific class to which an instance represented by the object belongs. The pointer occupies 4 bytes (or 8 bytes on the 64-bit machine).

The instance data is valid information actually stored for the object, and is also various types of field content defined in program code.

The alignment padding acts as a placeholder. An automatic memory management system of the hotspot virtual machine requires that a start address of the object should be an integer multiple of 8 bytes. In other words, a size of the object needs to be an integer multiple of 8 bytes. However, the object header is exactly a multiple of 8 bytes. Therefore, when the instance data of the object is not aligned, the alignment padding is required for completion.

### 3. Integrated Development Environment (IDE)

The IDE is an application used to provide a program development environment, and usually includes tools such as a code editor, a compiler, a debugger, and a graphical user interface. The IDE is a development software service suite that integrates a code writing function, an analysis function, a compilation function, a debugging function, and the like.

In the IDE, a code index is a separate and physical storage structure based on which values of all code in a current project and dependent components (code) in a mapping relationship are sorted. The code index indicates a set of values of one or more columns in a data table presenting a mapping relationship and a list of logical pointers correspondingly pointing to data that physically identifies the values in the table. Based on the list of the logical pointers, a specific information set, for example, a code index of all class method sets for a current class, can be quickly found through the IDE.

The code index is a basis for understanding the code in the IDE. All editing-related core capabilities of the IDE depend on the code index, including the following:
1. Code completion: Based on an input of a developer and existing project code, a class name, a method name, a code snippet, and the like are predicted for to-be-completed code in real time, and a suggestion list is provided for the developer. This can reduce entering workload and spelling errors. In addition, the developer does not need to spend a long time memorizing an unfamiliar class name and method name. Finally, development efficiency is improved.
2. Reference lookup: All references of a current symbol in a project are looked up.
3. Error check: A pre-compilation check function is provided to correct abnormal code in a project.
4. Intelligent jump: Quick browsing and jumping to a class, a file, and a symbol (finding a method or a field by using a name) are provided.
5. Syntactic highlighting: A sequence of syntactic special characters such as a keyword in a source file is rendered.
6. Code refactoring: Automatic code optimization functions such as symbol renaming and function extraction are provided.

A conventional code index is stored in a system at a granularity of an object. Generally, one code file corresponds to one code index, one code index is one object, and one object is stored as one file. Therefore, if code indexes of a plurality of code files need to be stored, a plurality of files (referred to as code index files below) are required. The plurality of code index files are in a one-to-one correspondence with the plurality of code files, and each code index file is used to store a code index of a corresponding code file. In addition, in some IDEs, different code index files may be stored in different file directories.

It is assumed that there are the following five objects:
object 1={studentIDno: “3286208”, lastname: “Neil”, firstname: “Abraham”, gender: “male”, classyear: “freshman” };
object 2={studentIDno: “3286209”, lastname: “Betty”, firstname: “Miller”, gender: “female”, classyear: “freshman” };
object 3={studentIDno: “3286210”, lastname: “Sally”, firstname: “Wagner”, gender: “female”, classyear: “freshman”};
object 4={studentIDno: “3286211”, lastname: “Joe”, firstname: “Brooks”, gender: “male”, classyear: “freshman” }; and
object 5={studentIDno: “3286212”, lastname: “Robin”, firstname: “Lee”, gender: “female”, classyear: “freshman” }.

For ease of description, the foregoing five objects may be represented by using Table 1.

TABLE 1

| Index | Student number | Last name | First name | Gender | Class year |
|---|---|---|---|---|---|
| 1 | 3286208 | Neil | Abraham | Male | Freshman |
| 2 | 3286209 | Betty | Miller | Female | Freshman |
| 3 | 3286210 | Sally | Wagner | Female | Freshman |
| 4 | 3286211 | Joe | Brooks | Male | Freshman |
| 5 | 3286212 | Robin | Lee | Female | Freshman |

Each of the five objects may include five attributes: a student number (studentIDno), a last name (lastname), a first name (firstname), a gender (gender), and a class year (classyear).

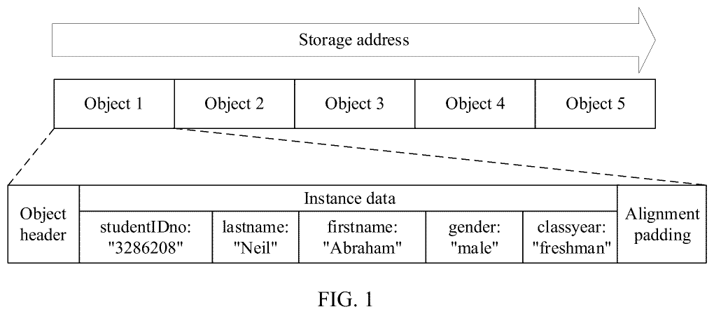

If an object is used as an example to read and store the five objects shown in Table 1, a storage space layout of the five objects may be shown in FIG. 1. As shown in FIG. 1, the object 1 to the object 5 are stored at consecutive storage addresses.

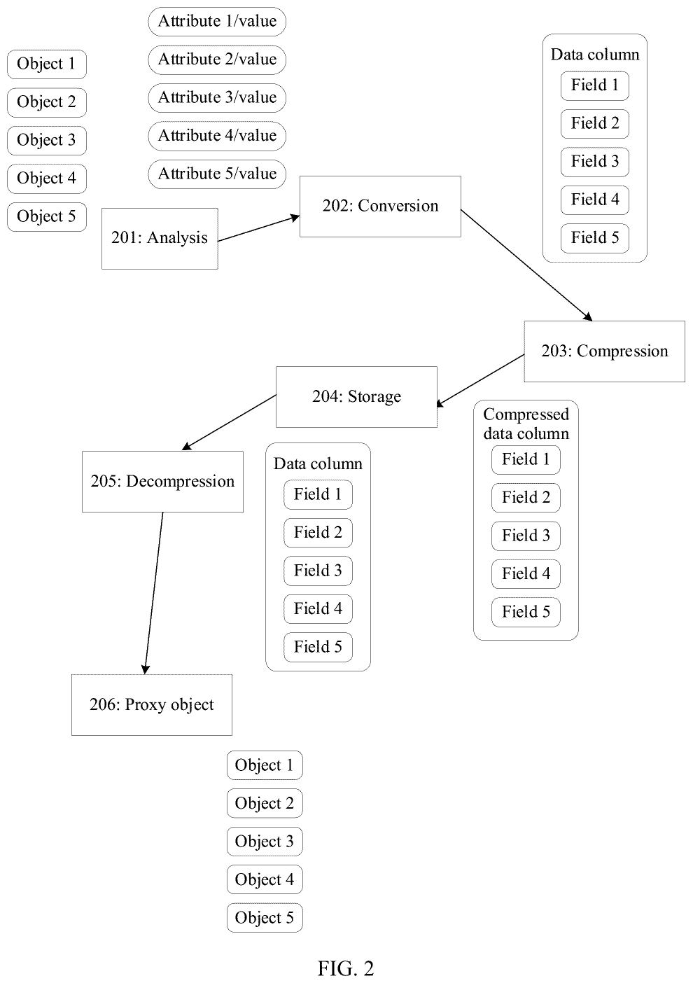

FIG. 2 is a schematic flowchart of a data processing method according to an embodiment of this application.
201: Analyze a to-be-stored object.
202: Perform format conversion.
203: Perform data compression.
204: Store compressed data.
205: Decompress data that needs to be read.
206: Restore data to an object by using a proxy object.

The following separately describes the steps in FIG. 2 with reference to the foregoing five objects.

It may be determined, by analyzing the to-be-stored object 1 to object 5, that the five objects belong to a same class. In other words, the five objects all include a same attribute value. In addition, an attribute value of each attribute of the to-be-stored object may be further determined by analyzing the to-be-stored object.

For example, attribute values of five attributes of the object 1 are respectively 3286208, Neil, Abraham, male, and freshman; attribute values of five attributes of the object 2 are respectively 3286209, Betty, Miller, female, and freshman; and so on.

Five data columns may be obtained by performing data conversion on attribute values. The five data columns are in a one-to-one correspondence with five attribute values, and each data column includes attribute values of a corresponding attribute of the object 1 to the object 5. For ease of description, the five data columns may be respectively referred to as a data column 1 to a data column 5. The data column 1 to the data column 5 include the following content:
data column 1={“3286208”, “3286209”, “3286210”, “3286211”, “3286212”};
data column 2={“Neil”, “Betty”, “Sally”, “Joe”, “Robin”};
data column 3={“Abraham”, “Miller”, “Wagner”, “Brooks”, “Lee”};
data column 4={“male”, “female”, “female”, “male”, “female”}; and
data column 5={“freshman”, “freshman”, “freshman”, “freshman”, “freshman”}.

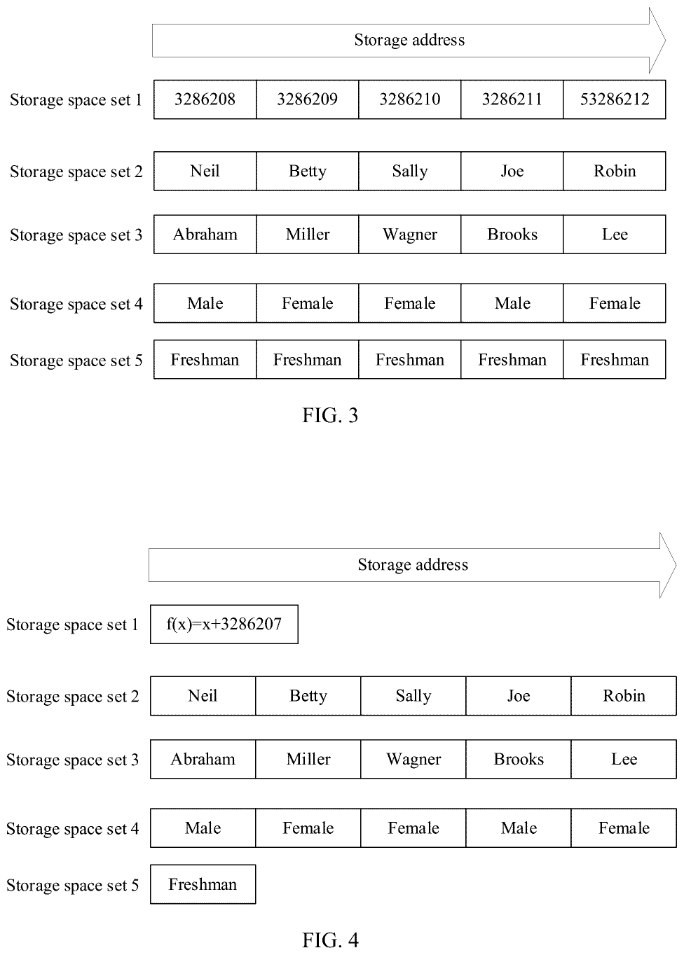

In some embodiments, the five data columns may be directly stored. In other words, in these embodiments, the data column does not need to be compressed (that is, step 203 does not need to be performed). Correspondingly, during reading, the stored data columns may be directly read without decompression (that is, step 205 does not need to be performed). In these embodiments, each of the foregoing five data columns may correspond to one storage space set, each storage space set includes five pieces of storage space with consecutive addresses, and the five pieces of storage space are respectively used to store five pieces of data in a corresponding data column. FIG. 3 shows a manner of storing a data column 1 to a data column 5. Unless otherwise specified, consecutive addresses in embodiments of this application mean consecutive virtual storage addresses.

A storage space set 1 to a storage space set 5 shown in FIG. 3 respectively correspond to the data column 1 to the data column 5. The storage space set 1 is used as an example. The storage space set corresponds to the data column 1, and the storage space set 1 includes five pieces of storage space with consecutive storage addresses. The five pieces of storage space respectively store attribute values of the attribute “student number” of the object 1 to the object 5 (namely, five pieces of data included in the data column 1). For another example, the storage space set 2 corresponds to the data column 2, and the storage space set 2 includes five pieces of consecutive storage space. The five pieces of storage space respectively store attribute values of the attribute “last name” of the object 1 to the object 5 (namely, five pieces of data included in the data column 2). For another example, the storage space set 5 corresponds to the data column 5, and the storage space set 5 includes five pieces of consecutive storage space. The five pieces of storage space respectively store attribute values of the attribute “class year” of the object 1 to the object 5 (namely, five pieces of data included in the data column 3).

In some embodiments, the data column may be further compressed before the data column is stored, and then a compressed data column is stored.

In some embodiments, if values of any two pieces of data included in one data column are the same, the data column may store only one piece of data.

The data column 1 to the data column 5 are used as an example. All data in the data column 5 is “freshman”. Therefore, the data column 5 may be compressed. A compressed data column 5 may store only one piece of data.

In some other embodiments, if data included in a data column may be determined based on a preset function, the data column may store the preset function. For example, the data in the data column 1 may be determined based on a linear function f(x)=x+3286207, where x is an index value of an object. For example, an index value of the object 1 is 1. In this case, it may be determined, based on the foregoing linear function, that the student number of the object 1 is 3286208. For another example, an index value of the object 5 is 5. In this case, it may be determined, based on the foregoing linear function, that the student number of the object 5 is 3286212. Therefore, the data column 1 may store the linear function.

In some embodiments, some data columns may not need to be compressed. For example, the foregoing compression solution cannot be used for the data column 2, the data column 3, and the data column 4. The data column 2, the data column 3, and the data column 4 may not need to be compressed. In this case, a compressed data column 1 to the compressed data column 5 are respectively:
data column 1={“f(x)=x+3286207”};
data column 2={“Neil”, “Betty”, “Sally”, “Joe”, “Robin”};
data column 3={“Abraham”, “Miller”, “Wagner”, “Brooks”, “Lee”};
data column 4={“male”, “female”, “female”, “male”, “female” }; and
data column 5={“freshman”}.

FIG. 4 shows a manner of storing a compressed data column 1 to a compressed data column 5.

As shown in FIG. 4, after compression, a storage space set 1 corresponding to the data column 1 needs to have only one piece of storage space. A storage space set 5 corresponding to the data column 5 also needs to have only one piece of storage space. A storage space set 2 corresponding to the data column 2, a storage space set 3 corresponding to the data column 3, and a storage space set 4 corresponding to the data column 4 still need to have five pieces of consecutive storage space.

When attribute values of the object 1 to the object 5 need to be read, a storage space set corresponding to an attribute may be determined. If the storage space set corresponding to the attribute is compressed data, the compressed data needs to be decompressed. If the storage space set corresponding to the attribute is uncompressed data, the data in the storage space set may be directly obtained.

For example, it is assumed that full names and class years of the object 1, the object 3, and the object 5 need to be read, data in the 1^{st} storage space, the 3^{rd} storage space, and the 5^{th} storage space in the storage space set 2, data in the 1^{st} storage space, the 3^{rd} storage space, and the 5^{th} storage space in the storage space set 3, and data in storage space in the storage space set 5 may be directly read to obtain the full names and the class years of the object 1, the object 3, and the object 5.

The foregoing technical solution can improve object storage efficiency. For example, in the foregoing technical solution, when data of an object is stored, some redundant information (for example, an object header and alignment padding) does not need to be stored. Therefore, the foregoing technical solution can reduce storage space required for storing the object, and reduce memory usage. In addition, in the foregoing technical solution, data of a plurality of objects of a same class can be stored by using only one file. This reduces a quantity of files that need to be stored.

In addition, in some embodiments, data is compressed, to further reduce storage space required for storing the data, and reduce memory usage.

Further, in some embodiments, the data is stored by using storage space with consecutive addresses, so that the data has good spatial locality.

Reading full names and class years of the object 1 to the object 5 is described by using the storage manner shown in FIG. 1 and the storage manner shown in FIG. 4 as examples.

It is assumed that, in the storage manner shown in FIG. 1, one object occupies 40 bytes (where an object header occupies 8 bytes, instance data occupies 29 bytes, and alignment padding occupies 3 bytes). In the storage manner shown in FIG. 4, one piece of storage space in the storage space set 2 occupies 8 bytes, one piece of storage space in the storage space set 3 occupies 8 bytes, and one piece of storage space in the storage space set 5 occupies 8 bytes.

In a conventional field access manner, a field can be accessed only after full object data is obtained through object reference. However, in the technical solution of this application, object reference and full object data loading can be skipped during field access, and a corresponding value in a data column corresponding to a field can be directly accessed. To be specific, if the full names and the class years of the object 1 to the object 5 need to be read in the conventional field access manner, the three fields “first name”, “last name”, and “class year” can be accessed to obtain the full names and the class years of the object 1 to the object 5 only after all data of the object 1 to the object 5 are obtained. However, according to the technical solution of this application, the full names and the class years of the object 1 to the object 5 can be obtained by accessing only the storage space sets used to store the three fields “first name”, “last name”, and “class year”.

It is assumed that a quantity of bytes that can be read through one cache read (cache load) is 128. In this case, for the storage manner shown in FIG. 1, if the full names and the class years of the object 1 to the object 5 need to be successfully read, storage space corresponding to the object 1 to the object 5 needs to be separately read to obtain the full names and the class years of the object 1 to the object 5. However, because storage space occupied by each object is 40 bytes, storage space corresponding to the five objects cannot be read at a time. Therefore, at least two cache reads in total are required to obtain the full names and the class years of the object 1 to the object 5.

However, for the storage manner shown in FIG. 4, the full names and the class years of the object 1 to the object 5 can be obtained by reading only the storage space set 2, the storage space set 3, and the storage space set 5. Because the storage space set 2, the storage space set 3, and the storage space set 5 occupy only 88 bytes in total, the full names and the class years of the object 1 to the object 5 can be successfully read through only one cache read. It can be learned that one cache read can be reduced in a case in which there are only five objects.

It may be understood that a larger quantity of objects indicates a larger quantity of reduced cache reads and a larger quantity of reduced cache misses. For example, it is assumed that other conditions remain unchanged but a quantity of objects increases from 5 to 100. In this case, if storage is performed in the manner shown in FIG. 1, full names and class years of the 100 objects can be obtained through 32 cache reads. However, if storage is performed in the manner shown in FIG. 4, full names and class years of the 100 objects can be obtained through only 13 cache reads. It can be learned that the technical solution of this application has good data consistency, and can effectively reduce a quantity of cache reads and a quantity of cache misses.

If the technical solution of this application is applied to a scenario in which code indexes are stored, because objects corresponding to all the code indexes belong to a same class, analysis, format conversion, data compression, and storage of compressed data can be performed on all the code indexes according to the solution in embodiments of this application. According to the technical solution of this application, all the code indexes can be stored by using only one file/one location, storage of redundant information can be effectively reduced, and memory usage can be reduced.

For example, it is assumed that one code index requires storage space of 32 bytes (where an object header occupies 8 bytes, instance data occupies 20 bytes, and alignment padding occupies 4 bytes). If a quantity of code indexes that need to be stored is 100, 100 files are required to store the code indexes, and the 100 files occupies storage space of 3200 bytes. In addition, the 100 files may be distributed at different locations for storage. However, if the technical solution of this application is used, only one file is required to store the 100 code indexes, and occupied storage space may be reduced to be less than 2000 bytes.

It may be understood that storing the code indexes by using the technical solution of this application is merely a possible application scenario of the technical solution of this application. The technical solution of this application may also be applied to another scenario in which an object needs to be stored. The application scenario of the technical solution of this application is not limited in embodiments of this application.

It may be understood that, although the attribute values of the objects are not compressed in the storage manner shown in FIG. 3, a plurality of attribute values of a same attribute are stored in consecutive storage space. Therefore, spatial locality is good.

Further, when data stored at a granularity of an object is read, reflection needs to be used to restore the data in storage space to an object. This process consumes a specific period of time. However, in the technical solution of this application, reading a group of data stored in storage space is equivalent to directly reading a two-dimensional array, and less time is consumed. Therefore, compared with the conventional technology, in the technical solution of this application, the data of the object can be obtained more quickly.

In some other embodiments, the data column 2, the data column 3, and the data column 4 may also be compressed.

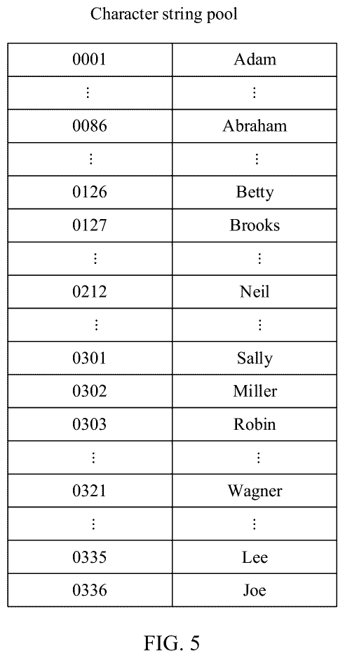

For example, in some embodiments, a system may store a character string pool. The character string pool may include a plurality of entries, and each entry includes one index value and one name. When a data column includes a name, an index value corresponding to the name may be determined from the character string pool. When the data column including the name is compressed, the index value corresponding to the name may be stored. FIG. 5 is a schematic diagram of a character string pool. The data column 2 and the data column 3 may be compressed based on the character string pool shown in FIG. 5. In addition, the gender may be identified by using 1 bit. For example, a gender with a value 1 indicates male, and a gender with a value 0 indicates female. In this case, a compressed data column 1 to a compressed data column 5 are respectively:
data column 1={“f(x)=x+3286207”};
data column 2={“0212”, “0126”, “0301”, “0336”, “0303”};
data column 3={“0086”, “0302”, “0321”, “0127”, “0335”};
data column 4={“1”, “0”, “0”, “1”, “O”}; and
data column 5={“freshman”}.

FIG. 6 shows a manner of storing a compressed data column 1 to a compressed data column 5.

As shown in FIG. 6, after compression, a storage space set 1 corresponding to the data column 1 needs to have only one piece of storage space. A storage space set 5 corresponding to the data column 5 also needs to have only one piece of storage space. A storage space set 2 corresponding to the data column 2, a storage space set 3 corresponding to the data column 3, and a storage space set 4 corresponding to the data column 4 still need to have five pieces of consecutive storage space. Although the storage space set 2 corresponding to the data column 2, the storage space set 3 corresponding to the data column 3, and the storage space set 4 corresponding to the data column 4 still need to have five pieces of consecutive storage space, each piece of storage space needs to store only four numbers. One number occupies storage space of 1 byte. Therefore, the storage space set 2 needs 20 bytes in total, the storage space set 3 needs 20 bytes in total, and the storage space set 4 needs 5 bytes in total. Therefore, the solution shown in FIG. 6 can further save storage space.

It may be understood that, when an attribute value is compressed, if a compressed attribute value needs to be read, a decompression solution may be determined based on an attribute corresponding to the attribute value that needs to be read. Then, the attribute value is determined based on data in a data column and the decompression solution. For example, the gender of the object 1 needs to be read. In this case, it may be determined, based on a correspondence between a bit and a gender, that the gender of the object 1 is male. For another example, if the first name of the object 1 needs to be read, it may be determined, based on the character string pool shown in FIG. 5 and an index value 0086 read from the storage space set 4, that the first name of the object 1 is Abraham.

It is further assumed that a quantity of bytes that can be read through one cache read (cache load) is 128. It is further assumed that 100 objects need to be read successfully. In this case, if storage is performed in the manner shown in FIG. 1, full names and class years of the 100 objects can be obtained through 32 cache reads. However, if storage is performed in the manner shown in FIG. 5, full names and class years of the 100 objects can be obtained through only 8 cache reads. In addition, storage performed in the manner shown in FIG. 5 requires storage space less than 1,000 bytes.

In some embodiments, a size of each piece of storage space in a storage space set may be equal to a size of maximum storage space occupied by data indicating an attribute value. For example, a maximum value of an attribute value corresponding to data of an int type is 255. In this case, storage space for storing the attribute value may be only 8 bits, instead of 32 bits.

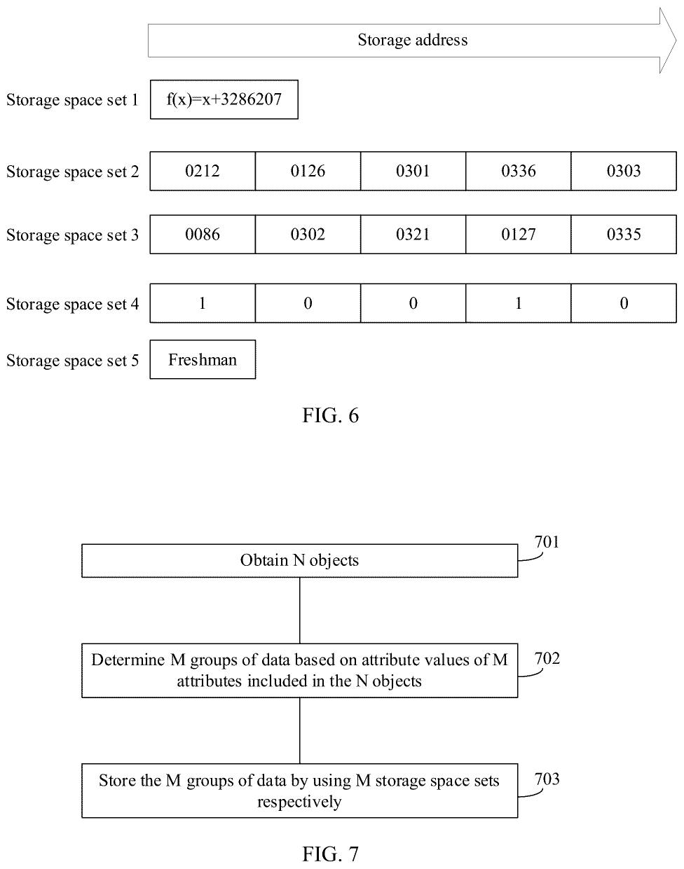

FIG. 7 is a schematic flowchart of a data processing method according to an embodiment of this application; and
701: Obtain N objects, where the N objects belong to a same class, each of the N objects includes M attributes, N is a positive integer greater than or equal to 2, and M is a positive integer greater than or equal to 1.
702: Determine M groups of data based on attribute values of the M attributes included in the N objects, where the M groups of data are in a one-to-one correspondence with the M attributes, and each of the M groups of data indicates attribute values of a corresponding attribute of the N objects.
703: Store the M groups of data by using M storage space sets respectively.

Optionally, in some embodiments, the determining M groups of data based on attribute values of the M attributes included in the N objects includes: determining, based on the attribute values of the M attributes included in the N objects, that the M attributes include M₁ first-type attributes, where attribute values of first attributes of any two of the N objects are different, the first attribute is any one of the M₁ first-type attributes, and M₁ is a positive integer greater than or equal to 1 and less than or equal to M; and determining M₁ groups of data, where the M₁ groups of data are in a one-to-one correspondence with the M₁ first-type attributes, N pieces of data included in an i^{th} group of data in the M₁ groups of data respectively indicate attribute values of an i^{th} first-type attribute in the M₁ first-type attributes of the N objects, and i=1, . . . , or M₁. The storing the M groups of data by using M storage space sets respectively includes: storing the M₁ groups of data by using M₁ first storage space sets, where an i^{th} first storage space set in the M₁ first storage space sets includes N pieces of consecutive storage space, and the N pieces of consecutive storage space in the i^{th} first storage space set are respectively used to store the N pieces of data included in the i^{th} group of data.

For example, attributes corresponding to the data column 2, the data column 3, and the data column 4 in the foregoing embodiments are first-type attributes.

In some embodiments, each piece of data in the M₁ groups of data may be an attribute value of a corresponding attribute. For example, the data may be data in the data column 2, the data column 3, or the data column 4 in the storage manner shown in FIG. 4.

In some other embodiments, each piece of data in the M₁ groups of data may be another piece of data that is determined based on an attribute value and that can indicate the attribute value. For example, in the storage manner shown in FIG. 6, the data column 2 and the data column 3 store index values that can indicate names, and the data column 5 stores bits that can indicate genders.

In some embodiments, the determining M groups of data based on attribute values of the M attributes included in the N objects includes: determining, based on the attribute values of the M attributes included in the N objects, that the M attributes include M₂ second-type attributes, where attribute values of second attributes of any two of the N objects are the same, the second attribute is any one of the M₂ second-type attributes, and M₂ is a positive integer greater than or equal to 1 and less than or equal to M; and determining M₂ groups of data, where data included in a j^{th} group of data in the M₂ groups of data indicates attribute values of a j^{th} second-type attribute in the M₂ second-type attributes of the N objects, and j=1, . . . , or M₂. The storing the M groups of data by using M storage space sets respectively includes: storing the M₂ groups of data by using M₂ second storage space sets, where storage space included in a j^{th} second storage space set in the M₂ second storage space sets is used to store the data included in the j^{th} group of data.

For example, attributes corresponding to the data column 5 in the foregoing embodiments are second-type attributes.

In some embodiments, the determining M groups of data based on attribute values of the M attributes included in the N objects includes: determining, based on the attribute values of the M attributes included in the N objects, that the M attributes include M₃ third-type attributes, where a third attribute of each of the N objects can be determined based on a function, the third attribute is any one of the M₃ third-type attributes, and M₃ is a positive integer greater than or equal to 1 and less than or equal to M; and determining M₃ groups of data, where a function included in a k^{th} group of data in the M₃ groups of data can determine attribute values of a k^{th} third-type attribute in the M₃ third-type attributes of the N objects, and k=1, . . . , or M₃; and the storing the M groups of data by using M storage space sets respectively includes: storing the M₃ groups of data by using M₃ third storage space sets, where storage space included in a k^{th} third storage space set in the M₃ third storage space sets is used to store the function included in the k^{th} group of data.

For example, attributes corresponding to the data column 1 in the foregoing embodiments are third-type attributes.

It may be understood that, in some embodiments, an attribute type of an object may include only the first-type attribute. In this case, M₁=M. Similarly, in some embodiments, the attribute type of the object may include only the second-type attribute or only the third-type attribute. When the attribute type includes only the second-type attribute, M₂=M. When the attribute type includes only the third-type attribute, M₃=M.

In some other embodiments, attribute types of an object may include the first-type attribute, the second-type attribute, and the third-type attribute. In this case, M₁+M₂+M₃=M.

In some other embodiments, attribute types of an object may include any two of the first-type attribute, the second-type attribute, and the third-type attribute. For example, the attribute types of the object may include only the first-type attribute and the second-type attribute. In this case, M₁+M₂=M. For another example, the attribute types of the object may include only the first-type attribute and the third-type attribute. In this case, M₁+M₃=M. For another example, the attribute types of the object may include only the second-type attribute and the third-type attribute. In this case, M₂+M₃=M.

If a group of data determined based on attribute values includes N pieces of data, and the N pieces of data are respectively N attribute values of a corresponding attribute, it may be considered that the attribute values are not compressed. For example, in the storage manner shown in FIG. 3, the data column 1 to the data column 5 are all uncompressed data. For another example, in the storage manner shown in FIG. 4, the data column 2, the data column 3, and the data column 4 are all uncompressed data.

If data included in a group of data determined based on attribute values is not the attribute values of a corresponding attribute, but the attribute values of the corresponding attribute can be determined according to a specific rule, it may be considered that the attribute values are compressed. For example, data in the data column 1 and the data column 5 in FIG. 4 is data obtained after attribute values of the attribute “student number” and the attribute “class year” are compressed. For another example, data in the data column 1 to the data column 5 in FIG. 6 is obtained by compressing attribute values of a corresponding attribute.

It may be understood that the foregoing attribute type and the foregoing compression manner are merely examples for attribute value compression. Based on an actual attribute value, an object may also include more types of attributes, and there may be more compression manners.

In some embodiments, attribute values of different attributes are stored only by using different storage space, and compression is not performed on the attribute values. For example, refer to the storage manner shown in FIG. 3.

In some other embodiments, attribute values of only some types may be compressed. For example, in the storage manner shown in FIG. 4, only the second-type attribute and the third-type attribute are compressed.

In some other embodiments, attribute values of all types may be compressed. For example, in the embodiment shown in FIG. 6, the first-type attribute, the second-type attribute, and the third-type attribute are all compressed.

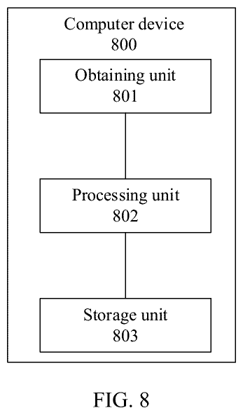

FIG. 8 is a schematic block diagram of a structure of a computer device according to an embodiment of this application. The computer device 800 shown in FIG. 8 includes an obtaining unit 801, a processing unit 802, and a storage unit 803.

The obtaining unit 801 is configured to obtain N objects, where the N objects belong to a same class, and each of the N objects includes M attributes.

The processing unit 802 is configured to determine M groups of data based on attribute values of the M attributes included in the N objects, where the M groups of data are in a one-to-one correspondence with the M attributes, and each of the M groups of data indicates attribute values of a corresponding attribute of the N objects.

The storage unit 803 is configured to store the M groups of data by using M storage space sets respectively.

For specific functions and beneficial effects of the obtaining unit 801, the processing unit 802, and the storage unit 803, refer to the foregoing embodiments. For brevity, details are not described herein again.

In some embodiments, the obtaining unit 801 and the processing unit 802 may be implemented by a processor. The storage unit 803 may be implemented by a memory.

An embodiment of this application further provides a computer device, including a processor and a memory. The processor is configured to be coupled to the memory, and read and execute instructions and/or program code in the memory, to perform the steps in the foregoing method embodiments.

It should be understood that the processor may be a chip. For example, the processor may be a field programmable gate array (FPGA), an application-specific integrated circuit (ASIC), a system on chip (SoC), a central processing unit (CPU), a network processor (NP), a digital signal processor (DSP), a micro controller unit (MCU), a programmable logic device (PLD), another programmable logic device, a discrete gate or a transistor logic device, a discrete hardware component, or another integrated chip.

In an implementation process, steps in the foregoing methods can be implemented by using a hardware integrated logic circuit in the processor, or by using instructions in a form of software. The steps of the method disclosed with reference to embodiments of this application may be directly performed by a hardware processor, or may be performed by a combination of hardware and software modules in the processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps of the foregoing method in combination with hardware of the processor. To avoid repetition, details are not described herein again.

It should be noted that, the processor in embodiments of this application may be an integrated circuit chip, and has a signal processing capability. In an implementation process, steps in the foregoing method embodiments can be implemented by using a hardware integrated logic circuit in the processor, or by using instructions in a form of software. The general-purpose processor may be a microprocessor, or the processor may be any conventional processor or the like. The steps of the methods disclosed with reference to embodiments of this application may be directly performed by a hardware decoding processor, or performed by a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory, and the processor reads information in the memory and completes the steps of the foregoing method in combination with hardware of the processor.

It may be understood that the memory in embodiments of this application may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), used as an external cache. By way of example and not limitation, many forms of RAMs are available, such as a static random access memory (SRAM), a dynamic random access memory (DRAM), a synchronous dynamic random access memory (SDRAM), double data rate synchronous dynamic random access memory (DDR SDRAM), an enhanced synchronous dynamic random access memory (enhanced SDRAM, ESDRAM), a synchlink dynamic random access memory (SLDRAM), and a direct rambus random access memory (DR RAM). It should be noted that the memory for the system and the method described in this specification aims to include but is not limited to these memories and any memory of another appropriate type.

According to the method provided in embodiments of this application, this application further provides a computer program product. The computer program product includes computer program code. When the computer program code is run on a computer, the computer is enabled to perform the steps in the foregoing embodiments.

According to the method provided in embodiments of this application, this application further provides a computer-readable medium. The computer-readable medium stores program code. When the program code is run on a computer, the computer is enabled to perform the steps in the foregoing embodiments.

According to the method provided in embodiments of this application, an embodiment of this application provides a chip system. The chip system includes a logic circuit. The logic circuit is configured to be coupled to an input/output interface, and transmit data through the input/output interface, to perform the steps in the foregoing embodiments.

A person of ordinary skill in the art may be aware that, in combination with the examples described in embodiments disclosed in this specification, units and algorithm steps may be implemented by electronic hardware or a combination of computer software and electronic hardware. Whether the functions are implemented by hardware or software depends on specific applications and design constraints of the technical solutions. A person skilled in the art may use different methods to implement the described functions for each particular application, but it should not be considered that the implementation goes beyond the scope of this application.

It may be clearly understood by a person skilled in the art that, for convenience and brevity of description, for a specific working process of the foregoing described system, apparatus, and unit, refer to a corresponding process in the foregoing method embodiments, and details are not described herein again.

In the several embodiments provided in this application, it should be understood that the disclosed system, apparatus, and method may be implemented in other manners. For example, the described apparatus embodiments are merely examples. For example, division into the units is merely logical function division. In actual implementation, there may be another division manner. For example, a plurality of units or components may be combined or integrated into another system, or some features may be ignored or not performed. In addition, the displayed or discussed mutual couplings or direct couplings or communication connections may be implemented through some interfaces, and indirect couplings or communication connections between apparatuses or units may be implemented in an electrical, mechanical, or another form.

The units described as separate parts may or may not be physically separate, and parts displayed as units may or may not be physical units, may be located in one place, or may be distributed on a plurality of network units. Some or all of the units may be selected according to an actual requirement to achieve the objectives of the solutions in the embodiments.

In addition, function units in embodiments of this application may be integrated into one processing unit, or each unit may exist alone physically, or two or more units may be integrated into one unit.

When the function is implemented in a form of a software function unit and sold or used as an independent product, the function may be stored in a computer-readable storage medium. Based on such an understanding, the technical solutions of this application essentially, or the part contributing to the conventional technology, or some of the technical solutions may be implemented in a form of a software product. The computer software product is stored in a storage medium and includes several instructions for instructing a computer device (which may be a personal computer, a server, or a network device) to perform all or some of the steps of the methods described in embodiments of this application. The foregoing storage medium includes any medium that can store program code, such as a USB flash drive, a removable hard disk, a read-only memory (ROM), a random access memory (RAM), a magnetic disk, or an optical disc.

The foregoing descriptions are merely specific implementations of this application. However, the protection scope of this application is not limited thereto. Any change or replacement readily figured out by a person skilled in the art within the technical scope disclosed in this application shall fall within the protection scope of this application. Therefore, the protection scope of this application shall be subject to the protection scope of the claims.

What is claimed is:

1. A data processing method in object-oriented programming (OOP) in an integrated development environment, comprising:
in the integrated development environment, obtaining N objects corresponding to code indexes, wherein the N objects belong to a same class of OOP, each of the N objects comprises M attributes, N is a positive integer greater than or equal to 2, and M is a positive integer greater than or equal to 1;
determining M groups of data based on attribute values of the M attributes comprised in each of the N objects, wherein the M groups of data are in a one-to-one correspondence with the M attributes, and each of the M groups of data indicates attribute values of a corresponding attribute of the N objects; and
storing the M groups of data by using M storage space sets respectively, wherein each storage space set comprises storage spaces with consecutive addresses.

2. The method according to claim 1, wherein the step of determining the M groups of data comprises:
determining, based on the attribute values of the M attributes comprised in each of the N objects, that the M attributes comprise M₁ first-type attributes, wherein attribute values of first attributes of any two of the N objects are different, the first attribute is any one of the M₁ first-type attributes, and M₁ is a positive integer greater than or equal to 1 and less than or equal to M; and
determining M₁ groups of data, wherein the M₁ groups of data are in a one-to-one correspondence with the M₁ first-type attributes, N pieces of data comprised in an i^{th} group of data in the M₁ groups of data respectively indicate attribute values of an i^{th} first-type attribute in the M₁ first-type attributes of the N objects, and i=1, . . . , or M₁, and
wherein the step of storing the M groups of data comprises:
storing the M₁ groups of data by using M₁ first storage space sets, wherein an i^{th} first storage space set in the M₁ first storage space sets comprises N pieces of consecutive storage space, and the N pieces of consecutive storage space in the i^{th} first storage space set are respectively used to store the N pieces of data comprised in the i^{th} group of data.

3. The method according to claim 1, wherein the step of determining the M groups of data comprises:
determining, based on the attribute values of the M attributes comprised in each of the N objects, that the M attributes comprise M₂ second-type attributes, wherein attribute values of second attributes of any two of the N objects are the same, the second attribute is any one of the M₂ second-type attributes, and M₂ is a positive integer greater than or equal to 1 and less than or equal to M; and
determining M₂ groups of data, wherein data comprised in a j^{th} group of data in the M₂ groups of data indicates attribute values of a j^{th} second-type attribute in the M₂ second-type attributes of the N objects, and j=1, . . . , or M₂, and
wherein the step of storing the M groups of data comprises:
storing the M₂ groups of data by using M₂ second storage space sets, wherein storage space comprised in a j^{th} second storage space set in the M₂ second storage space sets is used to store the data comprised in the j^{th} group of data.

4. The method according to claim 1, wherein the step of determining the M groups of data comprises:
determining, based on the attribute values of the M attributes comprised in each of the N objects, that the M attributes comprise M₃ third-type attributes, wherein a third attribute of each of the N objects can be determined based on a function, the third attribute is any one of the M₃ third-type attributes, and M₃ is a positive integer greater than or equal to 1 and less than or equal to M; and
determining M₃ groups of data, wherein a function comprised in a k^{th} group of data in the M₃ groups of data can determine attribute values of a k^{th} third-type attribute in the M₃ third-type attributes of the N objects, and k=1, . . . , or M₃, and
wherein the step of storing the M groups of data comprises:
storing the M₃ groups of data by using M₃ third storage space sets, wherein storage space comprised in a k^{th} third storage space set in the M₃ third storage space sets is used to store the function comprised in the k^{th} group of data.

5. The method according to claim 1, wherein a size of each piece of storage space in each of the M storage space sets is equal to a size of maximum storage space occupied by data indicating an attribute value.

6. The method according to claim 1, further comprising:
obtaining a read instruction instructing to read attribute values of P attributes of one or more of the N objects, wherein P is a positive integer greater than or equal to 1 and less than or equal to M;
determining P storage space sets from the M storage space sets, wherein the P storage space sets are in a one-to-one correspondence with the P attributes; and
respectively determining the attribute values of the P attributes of the one or more objects based on data comprised in the P storage space sets.

7. A computer device comprising:
a memory storing executable instructions; and
a processor configured to execute the executable instructions to:
in an integrated development environment, obtain N objects corresponding to code indexes, wherein the N objects belong to a same class in object-oriented programming (OOP), each of the N objects comprises M attributes, N is a positive integer greater than or equal to 2, and M is a positive integer greater than or equal to 1;
determine M groups of data based on attribute values of the M attributes comprised in each of the N objects, wherein the M groups of data are in a one-to-one correspondence with the M attributes, and each of the M groups of data indicates attribute values of a corresponding attribute of the N objects; and
store the M groups of data by using M storage space sets respectively, wherein each storage space set comprises storage spaces with consecutive addresses.

8. The computer device according to claim 7, wherein the processor is configured to determine the M groups of data by:
determining, based on the attribute values of the M attributes comprised in each of the N objects, that the M attributes comprise M₁ first-type attributes, wherein attribute values of first attributes of any two of the N objects are different, the first attribute is any one of the M₁ first-type attributes, and M₁ is a positive integer greater than or equal to 1 and less than or equal to M; and
determining M₁ groups of data, wherein the M₁ groups of data are in a one-to-one correspondence with the M₁ first-type attributes, N pieces of data comprised in an i^{th} group of data in the M₁ groups of data respectively indicate attribute values of an i^{th} first-type attribute in the M₁ first-type attributes of the N objects, and i=1, . . . , or M₁, and
wherein the processor is configured to store the M groups of data by:
storing the M₁ groups of data by using M₁ first storage space sets, wherein an i^{th} first storage space set in the M₁ first storage space sets comprises N pieces of consecutive storage space, and the N pieces of consecutive storage space in the i^{th} first storage space set are respectively used to store the N pieces of data comprised in the i^{th} group of data.

9. The computer device according to claim 7, wherein the processor is configured to determine the M groups of data by:
determining, based on the attribute values of the M attributes comprised in each of the N objects, that the M attributes comprise M₂ second-type attributes, wherein attribute values of second attributes of any two of the N objects are the same, the second attribute is any one of the M₂ second-type attributes, and M₂ is a positive integer greater than or equal to 1 and less than or equal to M; and
determining M₂ groups of data, wherein data comprised in a j^{th} group of data in the M₂ groups of data indicates attribute values of a j^{th} second-type attribute in the M₂ second-type attributes of the N objects, and j=1, . . . , or M₂, and
wherein the processor is configured to store the M groups of data by:
storing the M₂ groups of data by using M₂ second storage space sets, wherein storage space comprised in a j^{th} second storage space set in the M₂ second storage space sets is used to store the data comprised in the j^{th} group of data.

10. The computer device according to claim 7, wherein the processor is configured to determine the M groups of data by:
determining, based on the attribute values of the M attributes comprised in each of the N objects, that the M attributes comprise M₃ third-type attributes, wherein a third attribute of each of the N objects can be determined based on a function, the third attribute is any one of the M₃ third-type attributes, and M₃ is a positive integer greater than or equal to 1 and less than or equal to M; and
determining M₃ groups of data, wherein a function comprised in a k^{th} group of data in the M₃ groups of data can determine attribute values of a k^{th} third-type attribute in the M₃ third-type attributes of the N objects, and k=1, . . . , or M₃, and
wherein the processor is configured to store the M group of data by:
storing the M₃ groups of data by using M₃ third storage space sets, wherein storage space comprised in a k^{th} third storage space set in the M₃ third storage space sets is used to store the function comprised in the k^{th} group of data.

11. The computer device according to claim 7, wherein a size of each piece of storage space in each of the M storage space sets is equal to a size of maximum storage space occupied by data indicating an attribute value.

12. The computer device according to claim 7, wherein the processor is further configured to:
obtain a read instruction, wherein the read instruction is used to read attribute values of P attributes of one or more of the N objects, and P is a positive integer greater than or equal to 1 and less than or equal to M;
determine P storage space sets from the M storage space sets, wherein the P storage space sets are in a one-to-one correspondence with the P attributes; and
respectively determine the attribute values of the P attributes of the one or more objects based on data comprised in the P storage space sets.

13. A non-transitory computer readable medium having stored there executable instructions that, when executed by a processor of a computing device, cause the computing device to perform operations of:
in an integrated development environment, obtaining N objects corresponding to code indexes, wherein the N objects belong to a same class in object-oriented programming (OOP), each of the N objects comprises M attributes, N is a positive integer greater than or equal to 2, and M is a positive integer greater than or equal to 1;
determining M groups of data based on attribute values of the M attributes comprised in each of the N objects, wherein the M groups of data are in a one-to-one correspondence with the M attributes, and each of the M groups of data indicates attribute values of a corresponding attribute of the N objects; and
storing the M groups of data by using M storage space sets respectively, wherein each storage space set comprises storage spaces with consecutive addresses.

14. The non-transitory computer readable medium according to claim 13, wherein the operation of determining the M groups of data comprises:
determining, based on the attribute values of the M attributes comprised in each of the N objects, that the M attributes comprise M₁ first-type attributes, wherein attribute values of first attributes of any two of the N objects are different, the first attribute is any one of the M₁ first-type attributes, and M₁ is a positive integer greater than or equal to 1 and less than or equal to M; and
determining M₁ groups of data, wherein the M₁ groups of data are in a one-to-one correspondence with the M₁ first-type attributes, N pieces of data comprised in an i^{th} group of data in the M₁ groups of data respectively indicate attribute values of an i^{th} first-type attribute in the M₁ first-type attributes of the N objects, and i=1, . . . , or M₁, and wherein the operation of storing the M groups of data comprises:
storing the M₁ groups of data by using M₁ first storage space sets, wherein an i^{th} first storage space set in the M₁ first storage space sets comprises N pieces of consecutive storage space, and the N pieces of consecutive storage space in the i^{th} first storage space set are respectively used to store the N pieces of data comprised in the i^{th} group of data.

15. The non-transitory computer readable medium according to claim 13, wherein the operation of determining the M groups of data comprises:
determining, based on the attribute values of the M attributes comprised in each of the N objects, that the M attributes comprise M₂ second-type attributes, wherein attribute values of second attributes of any two of the N objects are the same, the second attribute is any one of the M₂ second-type attributes, and M₂ is a positive integer greater than or equal to 1 and less than or equal to M; and
determining M₂ groups of data, wherein data comprised in a j^{th} group of data in the M₂ groups of data indicates attribute values of a j^{th} second-type attribute in the M₂ second-type attributes of the N objects, and j=1, . . . , or M₂, and
wherein the operation of storing the M groups of data comprises:
storing the M₂ groups of data by using M₂ second storage space sets, wherein storage space comprised in a j^{th} second storage space set in the M₂ second storage space sets is used to store the data comprised in the j^{th} group of data.

16. The non-transitory computer readable medium according to claim 13, wherein the operation of determining the M groups of data comprises:
determining, based on the attribute values of the M attributes comprised in each of the N objects, that the M attributes comprise M₃ third-type attributes, wherein a third attribute of each of the N objects can be determined based on a function, the third attribute is any one of the M₃ third-type attributes, and M₃ is a positive integer greater than or equal to 1 and less than or equal to M; and
determining M₃ groups of data, wherein a function comprised in a k^{th} group of data in the M₃ groups of data can determine attribute values of a k^{th} third-type attribute in the M₃ third-type attributes of the N objects, and k=1, . . . , or M₃, and
wherein the operation of storing the M groups of data comprises:
storing the M₃ groups of data by using M₃ third storage space sets, wherein storage space comprised in a k^{th} third storage space set in the M₃ third storage space sets is used to store the function comprised in the k^{th} group of data.

17. The non-transitory computer readable medium according to claim 13, wherein a size of each piece of storage space in each of the M storage space sets is equal to a size of maximum storage space occupied by data indicating an attribute value.

18. The non-transitory computer readable medium according to claim 13, wherein the processor is configured to cause the computing device to perform further operations of:
obtaining a read instruction instructing to read attribute values of P attributes of one or more of the N objects, wherein P is a positive integer greater than or equal to 1 and less than or equal to M;
determining P storage space sets from the M storage space sets, wherein the P storage space sets are in a one-to-one correspondence with the P attributes; and
respectively determining the attribute values of the P attributes of the one or more objects based on data comprised in the P storage space sets.
